(19) United States
(12) Patent Application Publication
(10) Pub. No.: US 2019/0291564 A1
(43) Pub. Date: Sep. 26, 2019

(54) Transmission for a Motor Vehicle, and Drive Train for a Motor Vehicle

(71) Applicant: ZF Friedrichshafen AG, Friedrichshafen (DE)

(72) Inventors: Viktor Warth, Friedrichshafen (DE); Stefan Beck, Eriskirch (DE); Martin Brehmer, Tettnang (DE); Matthias Horn, Tettnang (DE); Johannes Kaltenbach, Friedrichshafen (DE); Julian King, Rankweil (AT); Jens Moraw, Markdorf (DE); Eckehard Münch, Bünde (DE); Gerhard Niederbrucker, Friedrichshafen (DE); Juri Pawlakowitsch, Kressbronn (DE); Stephan Scharr, Friedrichshafen (DE); Michael Wechs, Weißensberg (DE); Peter Ziemer, Tettnang (DE); Uwe Griesmeier, Markdorf (DE); Raffael Kuberczyk, Ravensburg (DE)

(21) Appl. No.: 16/302,868

(22) PCT Filed: Apr. 27, 2017
(86) PCT No.: PCT/EP2017/060106

§ 371 Date: Nov. 19, 2018

(30) Foreign Application Priority Data
May 19, 2016 (DE) 10 2016 208 669.3

(51) Int. Cl. B60K 6/365; B60K 6/48; B60K 6/547; F16H 3/66; F16H 3/72

(52) U.S. Cl. CPC B60K 6/365; B60Y 2200/92; B60K 6/547; F16H 3/663; F16H 3/724; B60K 2006/4816; F16H 2200/0047; F16H 2200/0056; F16H 2200/006; F16H 2200/0086; F16H 2200/201; F16H 2200/2012; F16H 2200/2043; F16H 2200/2046; B60K 6/48

(57) ABSTRACT

A transmission (G) for a motor vehicle includes an input shaft (GW1), an output shaft (GW2), a front-mounted gear set (VRS) with a first planetary gear set (P1) and a second planetary gear set (P2), a main gear set (HRS), an electric machine (EM) with a stator (S) and a rotor (R), and a plurality of shift elements. By selective engagement of three of the shift elements in each case, a plurality of fixed transmission ratios between the input shaft (GW1) and the output shaft (GW2) are shiftable. The two planetary gear sets (P1, P2) of the front-mounted gear set (VRS) include, in addition to the first shaft (Wx1) and the second shaft (Wx2), precisely three further shafts, namely a third shaft (Wx3), a fourth shaft (Wx4), and a fifth shaft (Wx5). A drive train for a motor vehicle may include such a transmission (G).

### FIELD OF THE INVENTION

The invention relates generally to a transmission for a motor vehicle, and to a drive train for a motor vehicle including such a transmission.

### BACKGROUND

Transmissions of a planetary design frequently include a so-called front-mounted or upstream gear set and a so-called main gear set. In this case, the main gear set frequently consists of a planetary gear set system, wherein an output shaft of the transmission is permanently connected to a shaft of the planetary gear set system. Individual shafts of the planetary gear set system can be rotationally fixed by shift elements operating as brakes, while a shaft of the planetary gear set system can be connected to an input shaft of the transmission by at least one clutch. The front-mounted gear set is utilized, together with further clutches, for making the rotational speed of the input shaft, as well as rotational speeds which are higher or lower by comparison, available to the shafts of the main gear set. Unexamined patent application DE 102 10 348 A1, which belongs to the applicant, offers an example of this type of transmission. The gear sets marked as RS2 and RS3 therein form the main gear set, upstream from which a front-mounted gear set marked as VS is installed.

Patent application US 2013/0150196 A1 shows, in FIG. 2, a transmission which includes a front-mounted gear set marked as PGS1 and a main gear set marked as PGS2. In this case, the front-mounted gear set includes two planetary gear sets including a total of four shafts, wherein an electric machine is connected to one of the four shafts and an input shaft of the transmission is connected to another one of the four shafts. The third of the four shafts can be rotationally fixed by engaging a brake which is marked as CL1. The last of the four shafts can be connected to different shafts of the main gear set by way of clutches. The brake CL1 is engaged in all fixed gear steps in this case, as is found in FIG. 4 of the aforementioned patent application, wherein, according to FIG. 18, when the brake CL1 is engaged, the electric machine is to rotate faster, in terms of absolute value, than the input shaft. Six forward gears can be implemented, in this way, with the aid of the brake CL1 and a further five shift elements.

### SUMMARY OF THE INVENTION

As used herein, a transmission means, in particular, a multi-stage transmission, in which a multitude of gears, i.e., fixed translation ratios between an input shaft and an output shaft of the transmission, are preferably automatically shiftable by shift elements. In this case, the shift elements are clutches or brakes, for example. Such transmissions are utilized primarily in motor vehicles in order to adapt the rotational speed and torque output characteristic of the drive unit to the driving resistances of the vehicle in a suitable way.

Example aspects of the invention provide a transmission with a front-mounted gear set and a main gear set, wherein the available shift elements are utilized in the best way possible.

The transmission according to the invention includes an input shaft, an output shaft, a front-mounted or upstream gear set including a first and a second planetary gear set, a main gear set, an electric machine including a rotationally fixed stator and a rotary rotor, as well as a plurality of shift elements. A plurality of fixed transmission ratios between the input shaft and the output shaft are available by way of selective engagement of three of the shift elements in each transmission ratio. The input shaft is permanently connected to a first shaft of the front-mounted gear set. The rotor of the electric machine is permanently connected to a second shaft of the front-mounted gear set. The output shaft is permanently connected to a first shaft of the main gear set.

According to example aspects of the invention, the front-mounted gear set includes, in addition to the first and the second shafts, precisely three further shafts, namely a third shaft, a fourth shaft, and a fifth shaft. The third shaft of the front-mounted gear set is permanently connected to a second shaft of the main gear set and is connectable to the fourth shaft of the front-mounted gear set by engaging a first one of the shift elements. The fourth shaft of the front-mounted gear set is rotationally fixable by engaging a second one of the shift elements. The fifth shaft of the front-mounted gear set is rotationally fixable by engaging a third one of the shift elements.

By way of engagement of the first one of the shift elements, two of the five shafts of the front-mounted gear set are connected to one another, and so the two planetary gear sets now form, in sum, four shafts. If two planetary gear sets, together, form four shafts, these two planetary gear sets are primarily distinguished by their kinematics and not by their configuration. The rotational speeds of the four shafts are linearly dependent on one another in this case as soon as the rotational speed of two of the four shafts has been defined. Upon engagement of the first one of the shift elements, the front-mounted gear set shafts assume the following rotational speed order: second shaft, fifth shaft, third shaft together with the fourth shaft, first shaft.

As used herein, the term “rotational speed order” is understood to mean the sequence of the front-mounted gear set shafts in terms of their linear rotational speed dependence. In other words, the rotational speed of the second front-mounted gear set shaft is less than or equal to the rotational speed of the fifth front-mounted gear set shaft. The rotational speed of the fifth front-mounted gear set shaft is, in turn, less than or equal to the rotational speed of the third front-mounted gear set shaft. The rotational speed of the third front-mounted gear set shaft is less than or equal to the rotational speed of the first front-mounted gear set shaft. This sequence is also reversible, and so the first front-mounted gear set shaft has the lowest rotational speed, while the second front-mounted gear set shaft assumes a rotational speed which is greater than or equal to the rotational speed of the first front-mounted gear set shaft. There is a linear relationship between the rotational speeds of all four front-mounted gear set shafts in this case. The rotational speed of one or several of the four front-mounted gear set shafts can also assume negative values or even the value zero in this case. The rotational speed order is therefore always to be related to the signed value of the rotational speeds, and not to their absolute value. If two of the four front-mounted gear set shafts are connected to one another, the four front-mounted gear set shafts have the same rotational speed.

The kinematics of the front-mounted gear set, according to example aspects of the invention, the assignment of the three shift elements to the five front-mounted gear set shafts, and the permanent connection of the front-mounted gear set to a main gear set shaft, to the input shaft and to the rotor of the electric machine make the following functions possible.
When the first shift element and the third shift element are engaged, and the second shift element is disengaged, the rotational speed of the third front-mounted gear set shaft is reduced as compared to the rotational speed of the input shaft. The engagement of the first and the third shift elements therefore brings about the rotational speed reduction which is typical for a front-mounted gear set.
When the first shift element and the second shift element are engaged, and the third shift element is disengaged, the third front-mounted gear set shaft is rotationally fixed. A separate brake for the rotational fixation of the second main gear set shaft, which is permanently connected to the third front-mounted gear set shaft, can therefore be omitted.
When the second shift element and the third shift element are engaged, and the first shift element is disengaged, the rotational speed order no longer exists—the two planetary gear sets operate as individual gear sets. A rotational speed reduction which is typical for a front-mounted gear set is brought about, in this case, with the aid of a suitable selection of the stationary transmission ratios of the two planetary gear sets of the front-mounted gear set. Preferably, this rotational speed reduction can differ from the rotational speed reduction brought about by the engagement of the first and the third shift elements. Particularly preferably, upon engagement of the second and the third shift elements, the rotational speed of the third front-mounted gear set shaft is reduced, as compared to the rotational speed of the input shaft, by a lesser extent than is the case upon engagement of the first and the third shift elements.

Given a suitable selection of the stationary transmission ratios of the two planetary gear sets of the front-mounted gear set, the rotor of the electric machine rotates faster, in terms of absolute value, than the input shaft. The electric machine can therefore be designed for higher rotational speeds and lower torque, given the same power demand, whereby the installation space requirement of the electric machine can be reduced. This is preferably implemented by selecting a stationary transmission ratio of the first planetary gear set which is greater in magnitude than the stationary transmission ratio, in magnitude, of the second planetary gear set. The stationary transmission ratio defines the speed ratio between the sun gear and the ring gear of a planetary gear set when the carrier is rotationally fixed. Since, in the case of a minus gear set, the direction of rotation between the sun gear and the ring gear reverses when the carrier is rotationally fixed, the stationary transmission ratio always assumes a negative value in the case of a minus gear set. When comparing the stationary transmission ratios of the first and the second planetary gear sets, it is assumed that the configuration of the two gear sets is similar, i.e., the first planetary gear set as well as the second planetary gear set are both designed as a minus gear set or as a plus gear set. A minus or negative gear set refers to a planetary gear set including a carrier, on which the planetary gears are rotatably mounted, and including a sun gear and a ring gear, wherein the tooth system of at least one of the planetary gears intermeshes both with the tooth system of the sun gear and with the tooth system of the ring gear, whereby the ring gear and the sun gear rotate in opposite directions of rotation when the sun gear rotates while the carrier is held. A plus or positive gear set differs from the above-described minus planetary gear set in that the plus gear set includes inner and outer planetary gears which are rotatably mounted on the carrier. The tooth system of the inner planetary gears intermeshes, in this case, with the tooth system of the sun gear, on the one hand, and with the tooth system of the outer planetary gears, on the other hand. In addition, the tooth system of the outer planetary gears intermeshes with the tooth system of the ring gear. As a result, the ring gear and the sun gear rotate in the same direction of rotation when the carrier is held. If a minus gear set is replaced by a plus gear set, in addition to changing the connection of the elements “carrier” and “ring gear”, the absolute value of the stationary transmission ratio must be increased by the value “one” in order to achieve the same transmission effect.

Each of the two planetary gear sets of the front-mounted gear set includes a first, a second, and a third element, which are preferably associated with the elements sun gear, carrier, and ring gear of the planetary gear sets in the following way: the first element is formed by the sun gear of the respective planetary gear set. In a design as a minus gear set, the second element is formed by the carrier of the respective planetary gear set and the third element is formed by the ring gear of the respective planetary gear set. In a design as a plus gear set, the second element is formed by the ring gear of the respective planetary gear set and the third element is formed by the carrier of the respective planetary gear set.

Preferably, the following assignment of the planetary gear set elements to the five front-mounted gear set shafts is selected: the third element of the second planetary gear set is an integral part of the first shaft of the front-mounted gear set. The first element of the first planetary gear set and the first element of the second planetary gear set are connected to one another and are integral parts of the second shaft of the front-mounted gear set. The third element of the first planetary gear set is an integral part of the third shaft of the front-mounted gear set. The second element of the second planetary gear set is an integral part of the fourth shaft of the front-mounted gear set. The second element of the first planetary gear set is an integral part of the fifth shaft of the front-mounted gear set. Such a configuration of the front-mounted gear set has a compact design and a good gearing efficiency.

According to a preferred first embodiment, the main gear set is designed as a planetary gear set system which includes, in addition to the first and the second shafts, precisely two further shafts, namely a third shaft and a fourth shaft. If four shafts form a planetary gear set system, the planetary gear set system is primarily distinguished by its kinematics and not by its configuration. The rotational speeds of the four shafts are linearly dependent on one another in this case as soon as the rotational speed of two of the four shafts has been defined.

The four shafts of the main gear set have the following rotational speed order in this case: second shaft, third shaft, first shaft, fourth shaft. As used herein, the term “rotational speed order” is understood to mean the sequence of the main gear set shafts in terms of their linear rotational speed dependence. In other words, the rotational speed of the second main gear set shaft is less than or equal to the rotational speed of the third main gear set shaft. The rotational speed of the third main gear set shaft, in turn, is less than or equal to the rotational speed of the first main gear set shaft. The rotational speed of the first main gear set shaft is less than or equal to the rotational speed of the fourth main gear set shaft. This sequence is also reversible, and so the fourth main gear set shaft has the lowest rotational speed, while the second main gear set shaft assumes a rotational speed which is greater than or equal to the rotational speed of the fourth main gear set shaft. There is always a linear relationship between the rotational speeds of all four main gear set shafts in this case. The rotational speed of one or several of the four main gear set shafts can also assume negative values or even the value zero in this case. The rotational speed order is therefore always to be related to the signed value of the rotational speeds, and not to their absolute value. If two of the four main gear set shafts are connected to one another, the four main gear set shafts have the same rotational speed.

The third shaft of the main gear set is rotationally fixable by engaging a fourth one of the shift elements. The input shaft is connectable to the fourth shaft of the main gear set by engaging a fifth shift element. The input shaft is connectable to the third shaft of the main gear set by engaging a sixth shift element. Due to such a configuration of the transmission according to the first embodiment, the formation of seven forward gears and at least one reverse gear is possible, as is explained in greater detail further below.

According to one possible configuration of the first embodiment, the planetary gear set system includes a first planetary gear set and a second planetary gear set, each of which includes a first element, a second element, and a third element. The first element is formed by the sun gear of the respective planetary gear set. In a design as a minus gear set, the second element is formed by the carrier of the respective planetary gear set and the third element is formed by the ring gear of the respective planetary gear set. In a design as a plus gear set, the second element is formed by the ring gear of the respective planetary gear set and the third element is formed by the carrier of the respective planetary gear set. The second element of the second planetary gear set and the third element of the first planetary gear set are connected to one another and are integral parts of the first shaft of the main gear set. The first element of the first planetary gear set is an integral part of the second shaft of the main gear set. The second element of the first planetary gear set and the third element of the second planetary gear set are integral parts of the third shaft of the main gear set. The first element of the second planetary gear set is an integral part of the fourth shaft of the main gear set. Such an embodiment allows for a compact configuration as well as a good gearing efficiency of the main gear set.

According to a preferred second embodiment, the main gear set is designed as a planetary gear set system which includes, in addition to the first and the second shafts, precisely three further shafts, namely a third shaft, a fourth shaft, and a fifth shaft. The fifth shaft of the planetary gear set system is permanently connected to the input shaft in this case. The third shaft of the planetary gear set system can be rotationally fixed by engaging a fourth one of the shift elements. The third shaft of the planetary gear set system can be connected to the fourth shaft of the planetary gear set system by engaging a fifth one of the shift elements, and so, when the fifth shift element is engaged, the shafts of the planetary gear set system have the following rotational speed order: second shaft, third shaft together with the fourth shaft, first shaft, fifth shaft. With respect to the rotational speed order, reference is made to the comments made with respect to the first embodiment. The input shaft can be connected to the third shaft of the planetary gear set system by engaging a sixth one of the shift elements.

In contrast to the first embodiment, in the transmission according to the second embodiment, a shaft of the main gear set is permanently connected to the input shaft, while the main gear set is now designed as a five-shaft transmission, similarly to the front-mounted gear set. The second embodiment can simplify the mounting of the input shaft and shorten the axial installation length of the transmission.

According to one possible configuration of the second embodiment, the planetary gear set system includes two planetary gear sets, each of which includes a first element, a second element, and a third element. The first element is always formed by the sun gear of the respective planetary gear set. In a design as a minus gear set, the second element is formed by the carrier of the respective planetary gear set and the third element is formed by the ring gear of the respective planetary gear set. In a design as a plus gear set, the second element is formed by the ring gear of the respective planetary gear set and the third element is formed by the carrier of the respective planetary gear set. The second element of the second planetary gear set and the third element of the first planetary gear set are connected to one another and are integral parts of the first shaft of the main gear set. The first element of the first planetary gear set is an integral part of the second shaft of the main gear set. The second element of the first planetary gear set is an integral part of the third shaft of the main gear set. The third element of the second planetary gear set is an integral part of the fourth shaft of the main gear set. The first element of the second planetary gear set is an integral part of the fifth shaft of the main gear set. Such an embodiment also allows for a compact configuration as well as a good gearing efficiency of the main gear set.

A configuration according to the first or the second embodiment makes it possible, by way of selective engagement of three of the shift elements, to form seven forward gears and at least one reverse gear between the input shaft and the output shaft. A first forward gear results by engaging the second, the fourth, and the fifth shift elements. In this case, the transmission ratio between the input shaft and the output shaft is already established by way of the engagement of the fourth and the fifth shift elements. By way of the engagement of the second shift element, the rotational speeds of the remaining shafts are also established, whereby the control of the transmission is simplified. A second forward gear results from engaging the first, the second, and the fifth shift elements. A third forward gear results from engaging the second, the third, and the fifth shift elements. A fourth forward gear results from engaging the second, the fifth, and the sixth shift elements. In this case, the transmission ratio between the input shaft and the output shaft is already established by way of the engagement of the fifth and the sixth shift elements. By way of the engagement of the second shift element, the rotational speeds of the remaining shafts are also established, whereby the control of the transmission is simplified. A fifth forward gear results from engaging the second, the third, and the sixth shift elements. A sixth forward gear results from engaging the first, the third, and the sixth shift elements. A seventh forward gear results from engaging the first, the second, and the sixth shift elements. As a result, given a suitable selection of the stationary transmission ratios of the gear sets, a transmission ratio range which is well suited for the application in a motor vehicle is achieved. In the event of a gear change between adjacent forward gears, in addition, only one shift element is to be disengaged and only one shift element is to be engaged in each case. This simplifies the gear change operation and shortens the shifting duration between adjacent forward gears. A reverse gear results by engaging the first, the third, and the fourth shift elements. Alternatively or in addition thereto, a reverse gear can also be formed by engaging the second, the third, and the fourth shift elements.

A configuration according to the first or the second embodiment also allows for a power-split operation between the input shaft, the electric machine, and the output shaft. As a result, the rotational speed of the output shaft can be steplessly changed given a predefined rotational speed of the input shaft and a specification of the rotor speed. Therefore, when the transmission is utilized in the motor vehicle drive train, a starting process can be implemented without using a separate or integrated starting component for providing a speed compensation between the transmission-external drive unit and the output shaft. A first power-split drive mode results by engaging the third shift element and the fifth shift element, wherein this first power-split drive mode is particularly suitable for the starting operation in the forward direction. A second power-split drive mode results by engaging the fourth shift element and the first shift element, wherein this second power-split drive mode is particularly suitable for the starting operation in the reverse direction.

A configuration according to the first or the second embodiment allows for further operating modes which are particularly suitable for an application in a hybrid vehicle. By engaging the fourth and the third shift elements, for example, a drive of the output shaft with the aid of the electric machine is possible without driving the input shaft. By engaging the second shift element or, alternatively, by engaging the first and the third shift elements, the electric machine can be driven with the aid of the input shaft, without driving the output shaft. As a result, an energy accumulator can be charged by way of the electric machine acting as a generator, without driving the motor vehicle. A powershift process between the fifth and the sixth forward gears can be supported with the aid of the electric machine, since the shift elements which remain engaged in this case produce a power-split condition between the input shaft, the output shaft, and the electric machine. This applies in the same way for a powershift process between the sixth and the seventh forward gears.

Preferably, the fourth shift element and/or the second shift element are/is designed as a form-fit shift element. Form-fit shift elements, in the engaged state, establish the connection via positive engagement and, in the disengaged state, are distinguished by lower drag losses than friction-locking shift elements. The efficiency of the transmission is improved due to the low drag losses in the disengaged condition. According to one alternative embodiment, the fourth shift element and/or the second shift element can be designed as a force-locking frictional shift element, the disks of which exclusively include non-lined friction faces. In other words, the disk-shaped base body of each disk of the frictional shift element includes no friction lining applied to the disk. The friction faces of individual disks or all disks of such a frictional shift element can be heat-treated, however, for example, nitrided. These types of frictional shift elements are designed for high contact pressures and, therefore, can be designed to have a small frictional surface and few disks. As a result, the drag losses of such a shift element can be reduced.

According to one possible embodiment, an interface of the transmission to a transmission-external drive unit and an interface of the output shaft to a transmission-internal or transmission-external differential gear are arranged coaxially to each other and at opposite axial ends of the transmission. The interface to the transmission-external drive unit is designed for transmitting a turning motion from the transmission-external drive unit to the transmission and can be designed, for example, as a flange or as a spline. The interface can be formed on the input shaft or on a connecting shaft which can be connected to the input shaft. The interface can also be formed, for example, on a hydrodynamic torque converter which is connected to the input shaft and acts as a starting component. The interface to the differential gear is aligned toward driving wheels of the motor vehicle in order to transmit a turning motion from the output shaft, with the intermediate connection of the differential gear. The axial distance between the interface to the transmission-external drive unit and the main gear set is greater, in this case, than the axial distance between the interface to the transmission-external drive unit and the front-mounted gear set. Such an arrangement is particularly suitable for the application of the transmission in a motor vehicle including a drive train aligned in parallel to the direction of travel of the motor vehicle.

According to one further possible embodiment, the interface of the output shaft is designed as a spur gear tooth system which intermeshes with one further spur gear tooth system of a shaft which is axially parallel to the output shaft. The interface of the output shaft has, in this case, a shorter axial distance to the interface of the input shaft than the front-mounted gear set. Such an arrangement is particularly suitable for the application of the transmission in a motor vehicle including a drive train aligned transversely to the direction of travel of the motor vehicle. Preferably, the main gear set is arranged axially between the spur gear tooth system of the output shaft and the front-mounted gear set. In other words, in such an arrangement, the front-mounted gear set is located at that axial end of the transmission which is opposite the interface to the transmission-external drive unit.

The transmission can include a connecting shaft which acts as an interface to a transmission-external drive unit, for example an internal combustion engine. The connecting shaft can be connected to the input shaft via a separating clutch. Alternatively thereto, the separating clutch, including the connecting shaft, can even be arranged outside the transmission. By disengaging the separating clutch, the motor vehicle can be driven by the electric machine in all gears of the transmission without entraining the transmission-external drive unit. The separating clutch can be designed as a form-fit or friction-locking shift element. The transmission can include a torsional vibration damper which is configured for damping torsional vibrations and is preferably arranged in the operative connection between two sections of the connecting shaft. The first section of the connecting shaft is associated with the interface to the transmission-external drive unit, and the second section of the connecting shaft is associated with the separating clutch. In this way, torsional vibrations generated by the transmission-external drive unit can be damped toward the input shaft.

In principle, a starting component can be installed upstream from the transmission in a known way, for example, a hydrodynamic torque converter or a friction clutch. Such a starting component can also be an integral part of the transmission. The starting component allows for a starting process when the transmission is utilized in the drive train of a motor vehicle, in that the starting component allows for a slip state between the internal combustion engine and the output shaft. Preferably, such a starting component is formed within the transmission, however, in that the fourth shift element is designed as a friction shift element. Due to the slip operation of the fourth shift element, a starting process is possible in the first forward gear and in the reverse gear. Therefore, a separate starting component can be omitted. If the fourth shift element is designed as a form-fit shift element or if it does not allow for a precise closed-loop control of a slip state, a slip state can be achieved during the starting operation with the aid of the fifth shift element for a starting process in the forward direction and with the aid of the third shift element for a starting process in the reverse direction. The third and the fifth shift elements are to be designed as suitable force-locking shift elements for this purpose.

The transmission can be an integral part of a drive train of a motor vehicle. The drive train includes, in addition to the transmission, an internal combustion engine which is torsionally elastically connected or can be torsionally elastically connected to the input shaft of the transmission via a torsional vibration damper. The separating clutch, which can be an integral part of the transmission, can be located between the input shaft and the internal combustion engine. The output shaft of the transmission is operatively connected, in a driving manner, to a differential gear which is operatively connected to wheels of the motor vehicle. If the transmission includes the electric machine, the drive train allows for multiple drive modes of the motor vehicle. In an electric mode, the motor vehicle is driven by the electric machine of the transmission. In an internal combustion engine-operated mode, the motor vehicle is driven by the internal combustion engine. In a hybrid mode, the motor vehicle is driven by the internal combustion engine as well as by the electric machine of the transmission.

As used herein, a permanent connection is referred to as a connection that always exists between two elements. Elements which are permanently connected in such a way always rotate with the same dependence between their speeds. No shift element may located in a permanent connection between two elements. A permanent connection is therefore to be distinguished from a shiftable connection. A permanently rotationally fixed connection is referred to as a connection that always exists between two elements and, therefore, the connected elements in the connection always have the same rotational speed.

As used herein, the expression “engage a shift element” in the context of gear formation is understood to mean an operation in which the shift element is controlled in such a way that the shift element transmits a high amount of torque at the end of the engagement operation. While form-fit shift elements do not permit a speed differential in the “engaged” state, in the case of friction-locking shift elements in the “engaged” state, a low speed differential can form between the shift-element halves, either intentionally or not.

### BRIEF DESCRIPTION OF THE DRAWINGS

Exemplary embodiments of the invention are described in detail in the following with reference to the attached figures. Wherein:

FIG. 1 shows an abstract representation of a transmission according to example aspects of the invention;

FIG. 2 shows a schematic of a transmission according to first exemplary embodiment of the invention;

FIG. 3 shows a speed diagram of the main gear set according to the first exemplary embodiment;

FIG. 4 shows a shift pattern of the transmission according to the first exemplary embodiment;

FIG. 5 shows a schematic of a transmission according to a second exemplary embodiment of the invention;

FIG. 6 shows a shift pattern of the transmission according to the second exemplary embodiment;

FIG. 7 shows a schematic of a transmission according to a third exemplary embodiment of the invention;

FIG. 8 shows a shift pattern of the transmission according to the third exemplary embodiment;

FIG. 9 shows a schematic of a transmission according to a fourth exemplary embodiment of the invention;

FIG. 10 shows a shift pattern of the transmission according to the fourth exemplary embodiment; and

FIG. 11 shows a drive train of a motor vehicle.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

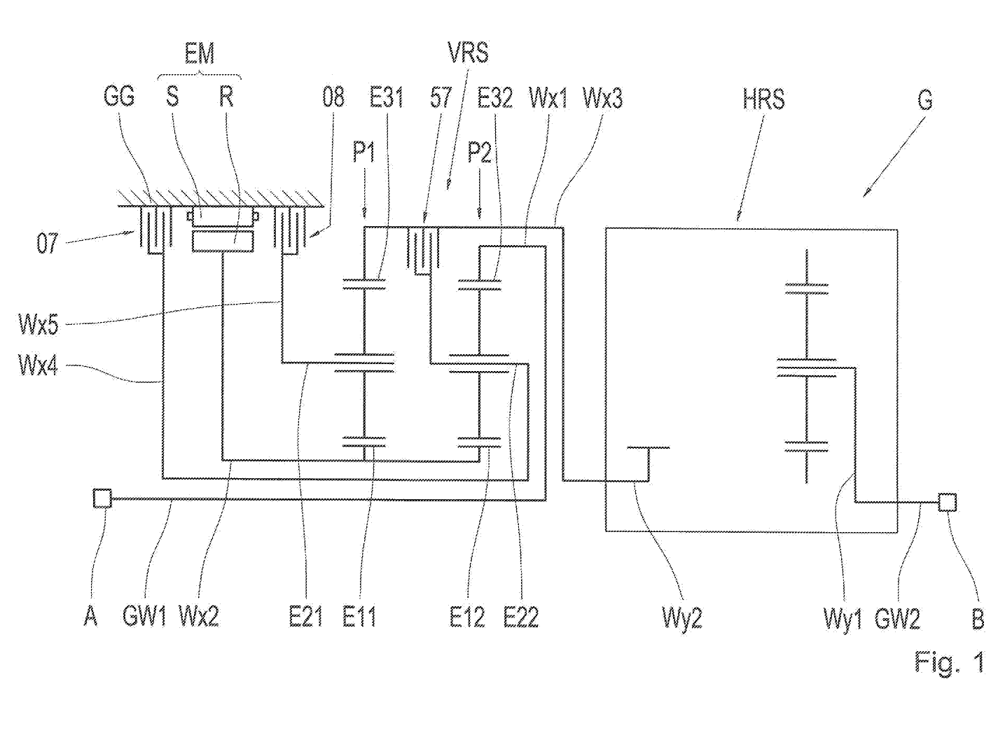

FIG. 1 shows an abstract representation of a transmission G according to example aspects of the invention. The transmission G includes an input shaft GW1, an output shaft GW2, an electric machine EM including a rotationally fixed stator S and a rotary rotor R, a front-mounted gear set VRS, and a main gear set HRS. The configuration of the front-mounted gear set VRS is represented by way of example, while the configuration of the main gear set HRS is merely indicated and various components of the main gear set HRS are not shown in detail. The main gear set HRS includes, in any case, several shafts, including a first shaft Wy1, which is permanently connected to the output shaft GW1, and a second shaft Wy2.

The front-mounted gear set VRS includes five shafts which are marked as first shaft Wx1, second shaft Wx2, third shaft Wx3, fourth shaft Wx4, and fifth shaft Wx5. The five shafts Wx1 to Wx5 of the front-mounted gear set VRS are formed by the elements of a first planetary gear set P1 and a second planetary gear set P2. Each of the two planetary gear sets P1, P2 includes a first element E11, E12, a second element E21, E22, and a third element E31, E32. The first element E11, E12 is formed by a sun gear of the respective planetary gear set P1, P2. When the planetary gear set is designed as a minus gear set, the second element E21, E22 is formed by a carrier of the respective planetary gear set P1, P2 and the third element E31, E32 is formed by the ring gear of the respective planetary gear set P1, P2. In the embodiment of the transmission G represented in FIG. 1, the planetary gear sets P1, P2 are designed as minus gear sets.

The third element E32 of the second planetary gear set P2 is an integral part of the first shaft Wx1 of the front-mounted gear set VRS, and is permanently connected to the input shaft GW1. The first element E11 of the first planetary gear set P1 and the first element E12 of the second planetary gear set P2 are permanently connected to one another and are integral parts of the second shaft Wx2 of the front-mounted gear set VRS, which is permanently connected to the rotor R of the electric machine EM. The third element E31 of the first planetary gear set P1 is an integral part of the third shaft Wx3 of the front-mounted gear set VRS, which is permanently connected to the second shaft Wy2 of the main gear set HRS. The second element E22 of the second planetary gear set P2 is an integral part of the fourth shaft Wx4 of the front-mounted gear set VRS. The second element E21 of the first planetary gear set P1 is an integral part of the fifth shaft Wx5 of the front-mounted gear set VRS.

The transmission G includes a plurality of shift elements, including a first shift element 57, a second shift element 07, and a third shift element 08. By way of engagement of the first shift element 57, the third front-mounted gear set shaft Wx3 is connected to the fourth front-mounted gear set shaft Wx4. By way of engagement of the second shift element 07, the fourth front-mounted gear set shaft Wx4 is rotationally fixed, in that it is connected to a rotationally fixed component GG of the transmission G. The rotationally fixed component can be formed, for example, by the housing of the transmission G. By way of engagement of the third shift element 08, the fifth shaft Wx5 of the front-mounted gear set VRS is rotationally fixable in the same way.

It is to be noted that the main gear set HRS can have various designs. The main gear set HRS can include, for example, only one single planetary gear set, or even a plurality of planetary gear sets. The main gear set could also be designed as a countershaft transmission. Shift elements can be associated with the main gear set HRS, with the aid of which individual shafts of the main gear set HRS is rotationally fixable or connectable to the input shaft GW1. By way of the shift elements, individual shafts of the main gear set HRS are also connectable to one another. Specific embodiments of transmissions G are described in detail in the following exemplary embodiments.

The input shaft GW1 includes an interface A to a transmission-external drive unit. The output shaft includes an interface B to a transmission-external or transmission-internal differential gear. The interfaces A, B are arranged coaxially to each other and at opposite axial ends of the transmission G in this case. The interface A is designed for transmitting a turning motion from the transmission-external drive unit to the transmission G and can be designed, for example, as a flange or as a spline. The interface A can be formed on the input shaft GW1 or on a connecting shaft which can be connected to the input shaft GW1. The interface A can also be formed, for example, on a hydrodynamic torque converter which is connected to the input shaft GW1 and acts as a starting component. The interface B of the output shaft GW2 is aligned toward driving wheels of the motor vehicle in order to transmit a turning motion from the output shaft GW2, with the intermediate connection of the differential gear.

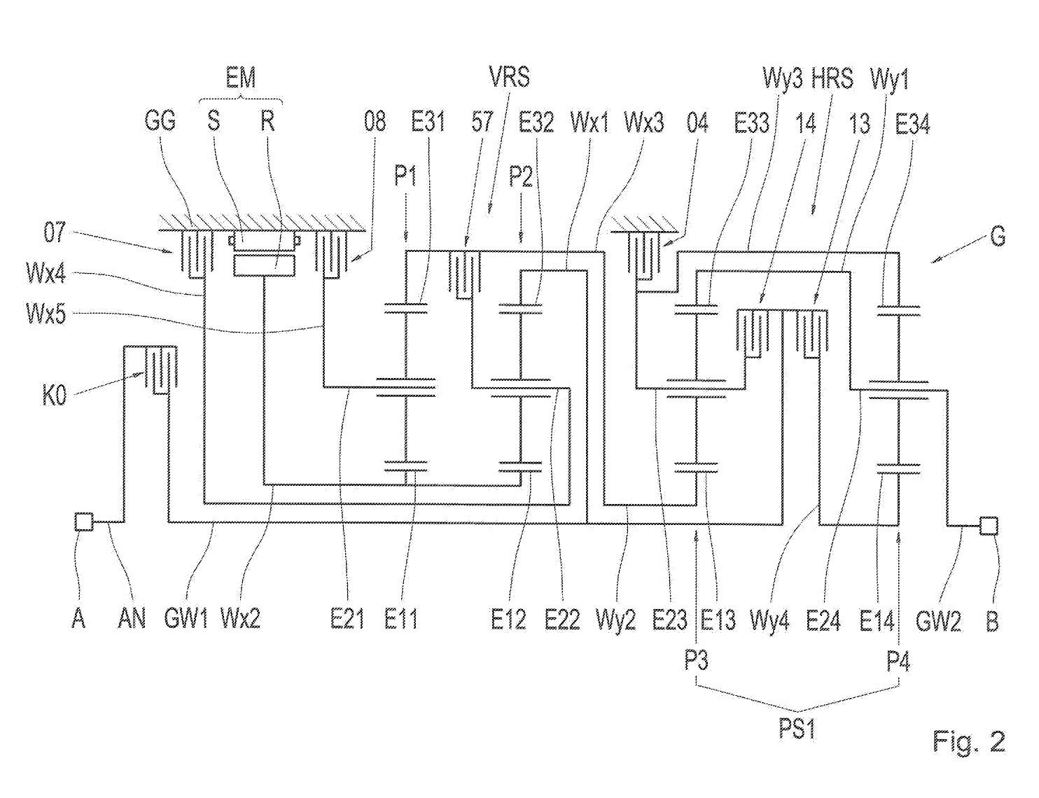

FIG. 2 shows a schematic of a transmission G according to a first exemplary embodiment of the invention. The main gear set HRS includes, in this case, a planetary gear set system PS1 which includes a first planetary gear set P3 and a second planetary gear set P4. Each of the two planetary gear sets P3, P4 includes a first element E13, E14, a second element E23, E24, and a third element E33, E34. The first element E13, E14 is formed by a sun gear of the respective planetary gear set P3, P4. When the planetary gear set is designed as a minus gear set, the second element E23, E24 is formed by a carrier of the respective planetary gear set P3, P4 and the third element E33, E34 is formed by the ring gear of the respective planetary gear set P3, P4. In the first embodiment of the transmission G represented in FIG. 2, the planetary gear sets P3, P4 are designed as minus gear sets.

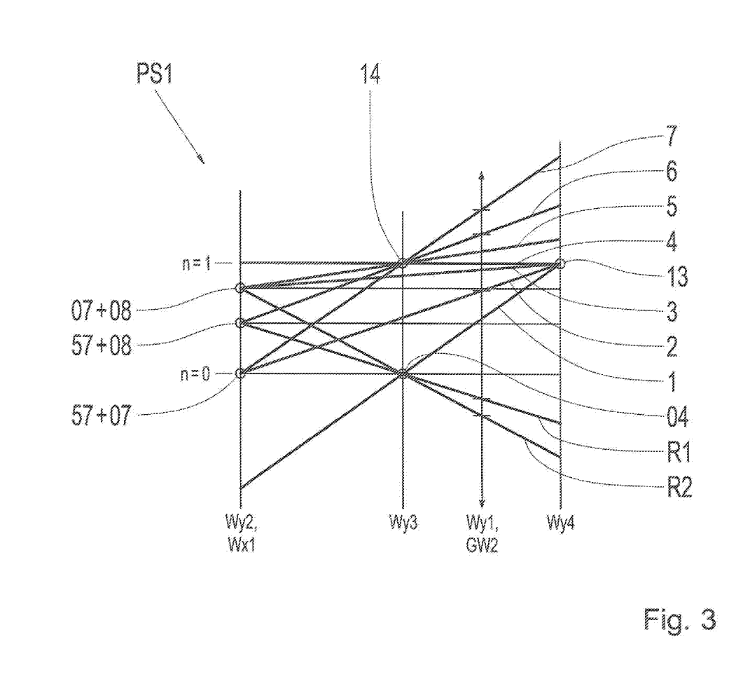

The planetary gear set system PS1 includes precisely four shafts in this case, namely the first shaft Wy1 connected to the output shaft GW2, the second shaft Wy2 connected to the third shaft Wx3 of the front-mounted gear set VRS, a third shaft Wy3, and a fourth shaft Wy4. A planetary gear set system consisting of two individual planetary gear sets which, together, form four shafts, can also be described by its kinematics. Examples thereof are the so-called Ravigneaux gear set or the Simpson gear set. The four shafts of these types of planetary gear set systems have a rotational speed order which is described in detail, by way of example, further below with reference to FIG. 3.

In the exemplary embodiment according to FIG. 2, the first shaft Wy1 of the main gear set HRS is permanently connected to the third element E33 of the first planetary gear set P3 and to the second element E24 of the second planetary gear set P4. The second shaft Wy2 of the main gear set HRS is permanently connected to the first element E13 of the first planetary gear set P3. The third shaft Wy3 of the main gear set HRS is permanently connected to the second element E23 of the first planetary gear set P3 and to the third element E34 of the second planetary gear set P4. In addition, the third shaft Wy3 of the main gear set HRS is rotationally fixable by engaging a fourth shift element 04. The fourth shaft Wy4 of the main gear set HRS is permanently connected to the first element E14 of the second planetary gear set P4 and is connectable to the input shaft GW1 via a fifth shift element 13. The third shaft Wy3 of the main gear set HRS is connectable to the input shaft GW1 by engaging a sixth shift element 14.

The transmission G according to the first exemplary embodiment represented in FIG. 1 includes a connecting shaft AN which is connectable to the input shaft GW1 via a separating clutch K0. These two components are optional components of the transmission G. The interface A is formed on the connecting shaft AN.

FIG. 3 shows a speed diagram of the planetary gear set system PS1 according to the transmission G of the first exemplary embodiment represented in FIG. 2. The four vertical lines describe the rotational speed of each of the four main gear set shafts Wy1 to Wy4 in relationship to a predefined rotational speed n of the input shaft GW1, which has been standardized to the value one. The distance between the vertical lines results from the stationary transmission ratios of the planetary gear sets P3, P4. The representation shown in FIG. 3 is not full scale.

Circles arranged on the vertical lines show the effect of the six shift elements 57, 07, 08, 04, 13, 14. When, for example, the input shaft GW1 is connected to the fourth shaft Wy4 by engaging the fifth shift element 13, the fourth shaft Wy4 and the input shaft GW1 have a speed ratio equal to one. When the fourth shift element 04 is engaged, the rotational speed of the third shaft Wy3 is equal to zero. The three shift elements 57, 07, 08 associated with the front-mounted gear set VRS yield their effect by way of engagement of two of the three shift elements 57, 07, 08. When the first shift element 57 and the second shift element 07 are engaged, the second shaft W2y is rotationally fixed and, therefore, assumes the value zero. When the first shift element 57 and the third shift element 08 are engaged, the rotational speed of the second shaft W2y is reduced in relation to the rotational speed n of the input shaft GW1. When the second shift element 07 and the third shift element 08 are engaged, the rotational speed of the second shaft W2y is also reduced in relation to the rotational speed n of the input shaft GW1, although to a lesser extent than during the engagement of the first shift element 57 and the third shift element 08.

By predefining the rotational speeds at two of the four shafts Wy1 to Wy4 of the main gear set HRS, the rotational speeds of all four shafts Wy1 to Wy4 of the main gear set HRS are established. This is apparent on the basis of a straight-line connection of two of the circles. According thereto, the rotational speeds of the four shafts Wy1 to Wy4 are linearly dependent on one another as soon as the rotational speed of two of the four shafts Wy1 to Wy4 has been defined. The sequence of the vertical lines in the speed diagram shows the rotational speed order in this case, which, in the example given, assumes the following sequence: second shaft Wy2, third shaft Wy3, first shaft Wy1, fourth shaft Wy4.

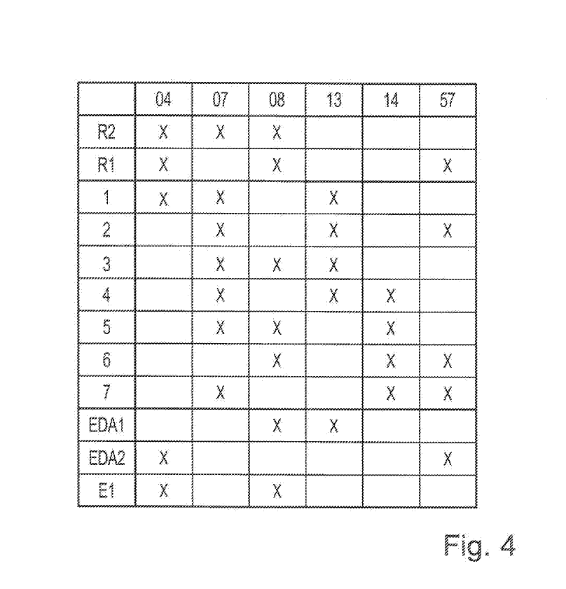

FIG. 4 shows a shift pattern which can be applied for the transmission G according to the first exemplary embodiment. In the rows of the shift pattern, two reverse gears R1, R2 and a first to seventh forward gear 1 to 7 are indicated. In the columns of the shift pattern, an X indicates which of the shift elements 04, 07, 08, 13, 14, 57 is engaged in which gear 1 through 7 and R1, R2. The gears refer to fixed transmission ratios between the input shaft GW1 and the output shaft GW2 in this case. In combination with the shift pattern represented in FIG. 4 and the speed diagram represented in FIG. 3, the gear implementation of the transmission G becomes clear. A first forward gear 1 results from engaging the fourth shift element 04 and the fifth shift element 13. As a result, the transmission ratio between the input shaft and the output shaft is already established. The rotational speeds of the remaining shafts are also established by engaging the second shift element 07. A second forward gear 2 results from engaging the first shift element 57, the second shift element 07, and the fifth shift element 13. A third forward gear 3 results from engaging the second shift element 07, the third shift element 08, and the fifth shift element 13. A fourth forward gear 4 results from engaging the fifth shift element 13 and the sixth shift element 14. As a result, the transmission ratio between the input shaft and the output shaft is already established. The rotational speeds of the remaining shafts are also established by engaging the second shift element 07. A fifth forward gear 5 results from engaging the second shift element 07, the third shift element 08, and the sixth shift element 14. A sixth forward gear 6 results from engaging the first shift element 57, the third shift element 08, and the sixth shift element 14. A seventh forward gear 7 results from engaging the first shift element 57, the second shift element 07, and the sixth shift element 14. A first reverse gear marked as R1 results from engaging the first shift element 57, the third shift element 08, and the fourth shift element 04. A second reverse gear R2 can be implemented by engaging the second shift element 07, the third shift element 08, and the fourth shift element 04. A first power-split drive mode EDA1 results by engaging the third shift element 08 and the fifth shift element 13. A second power-split drive mode EDA2 results by engaging the first shift element 57 and the fourth shift element 04. An electric drive mode E1 results by engaging the third shift element 08 and the fourth shift element 04.

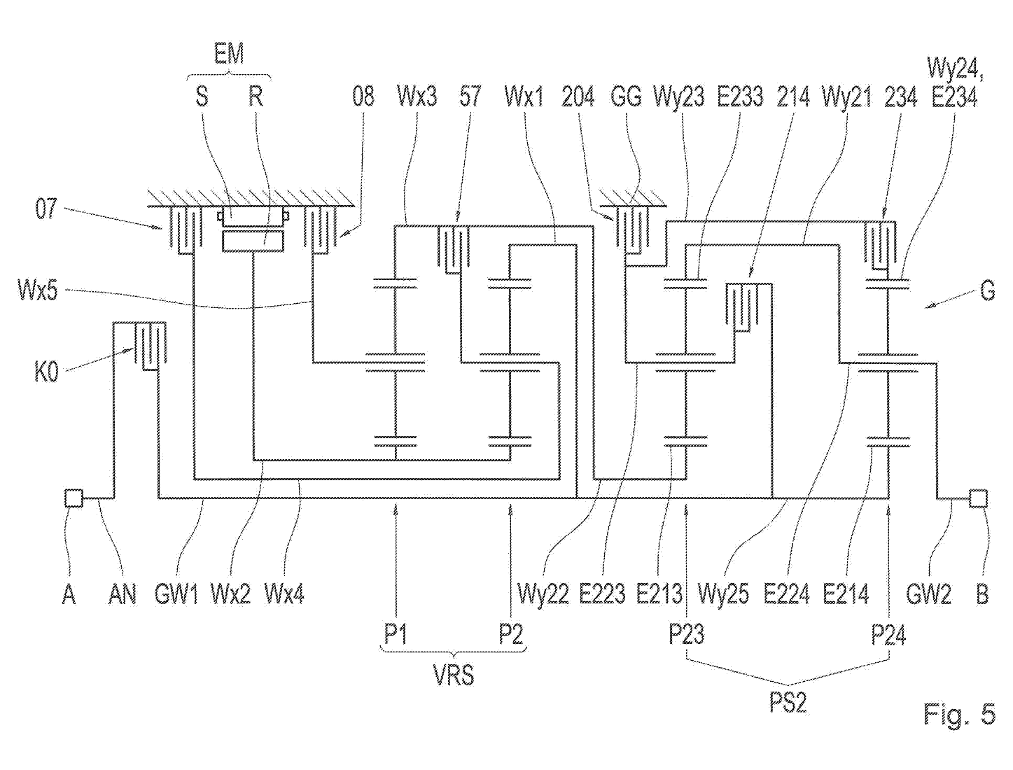

FIG. 5 shows a schematic of a transmission G according to a second exemplary embodiment of the invention. The main gear set HRS includes, in this case, a planetary gear set system PS2 which includes a first planetary gear set P23 and a second planetary gear set P24. Each of the two planetary gear sets P23, P24 includes a first element E213, E214, a second element E223, E224, and a third element E233, E234. The first element E213, E214 is formed by a sun gear of the respective planetary gear set P23, P24. When the planetary gear set is designed as a minus gear set, the second element E223, E224 is formed by a carrier of the respective planetary gear set P23, P24 and the third element E233, E234 is formed by the ring gear of the respective planetary gear set P23, P24. In the second exemplary embodiment of the transmission G represented in FIG. 5, the planetary gear sets P23, P24 are designed as minus gear sets.

The planetary gear set system PS2 includes precisely five shafts in this case, namely the first shaft Wy21 connected to the output shaft GW2, the second shaft Wy22 connected to the third shaft Wx3 of the front-mounted gear set VRS, a third shaft Wy23, a fourth shaft Wy24, and a fifth shaft Wy25. In the exemplary embodiment according to FIG. 5, the first shaft Wy21 of the main gear set HRS is permanently connected to the third element E233 of the first planetary gear set P23 and to the second element E224 of the second planetary gear set P24. The second shaft Wy22 of the main gear set HRS is permanently connected to the first element E213 of the first planetary gear set P23. The third shaft Wy23 of the main gear set HRS is permanently connected to the second element E223 of the first planetary gear set P23. In addition, the third shaft Wy23 of the main gear set HRS is rotationally fixable by engaging a fourth shift element 204. The fourth shaft Wy24 of the main gear set HRS is permanently connected to the third element E234 of the second planetary gear set P24. The fifth shaft Wy25 of the main gear set HRS is permanently connected to the first element E214 of the second planetary gear set P24 and is permanently connected to the input shaft GW1. The third shaft Wy23 of the main gear set HRS is connectable to the fourth shaft Wy24 of the main gear set HRS by engaging a fifth shift element 234, and is connectable to the input shaft GW1 by engaging a sixth shift element 214.

The difference between the first exemplary embodiment and the second exemplary embodiment is therefore essentially the coupling between the first element E14, E214 of the second planetary gear set P4, P24 and the input shaft GW1, on the one hand, and the coupling between the second element E23, E223 of the first planetary gear set P3, P23 and the third element E34, E234 of the second planetary gear set P4, P24, on the other hand. One of the two couplings is designed as a permanently rotationally fixed connection in this case, while the other of the two components is designed as a connection which can be established with the aid of the fifth shift element 13, 234.

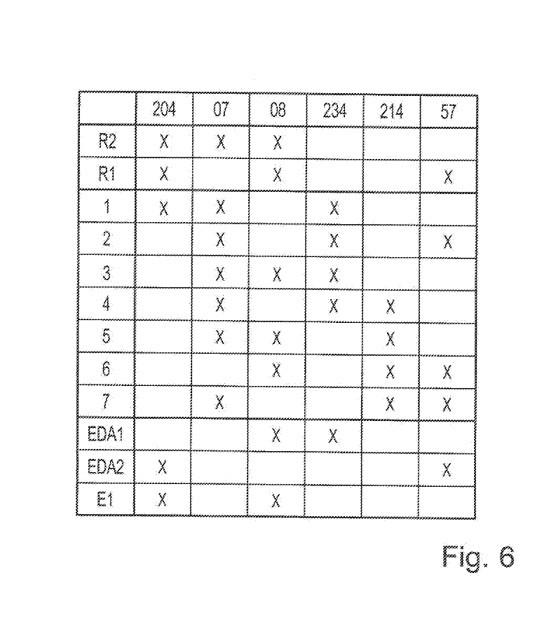

FIG. 6 shows a shift pattern which can be applied for the transmission G according to the second exemplary embodiment. In the rows of the shift pattern, two reverse gears R1, R2, a first through seventh forward gear 1 to 7, two power-split drive modes EDA1, EDA2 and an electric drive mode E1 are indicated. In the columns of the shift pattern, an X indicates which of the shift elements 204, 07, 08, 234, 214, 57 is engaged in which gear 1 to 7 and R1, R2, and operating modes EDA1, EDA2, E1.

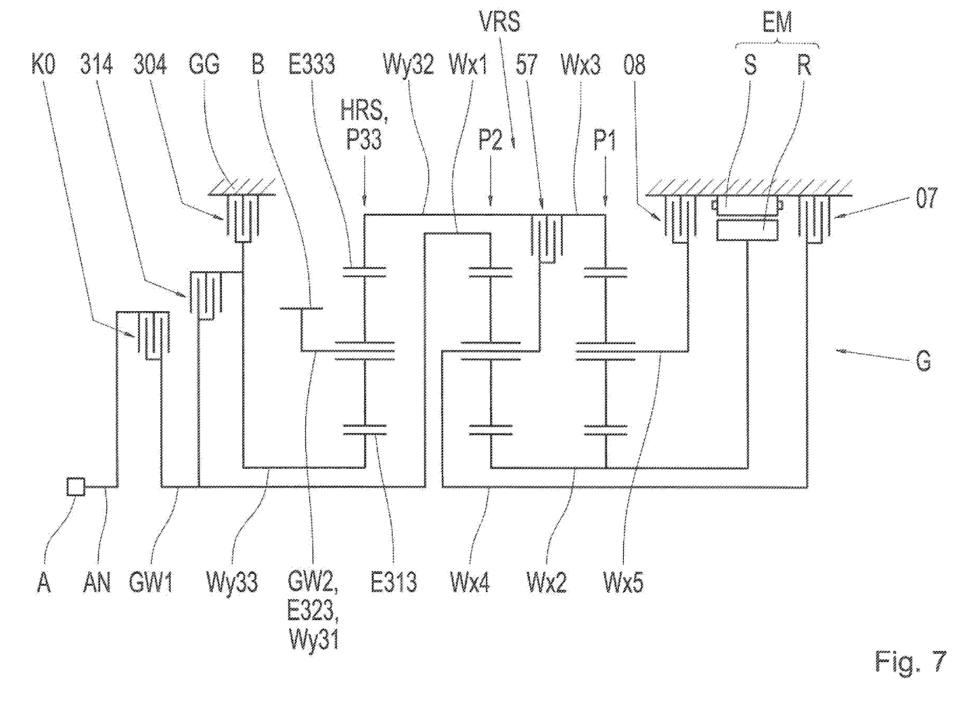

FIG. 7 shows a schematic of a transmission G according to a third exemplary embodiment of the invention. The main gear set HRS includes a single planetary gear set P33 in this case, which includes a first element E313, a second element E323, and a third element E333. The first element E313 is formed by a sun gear of the planetary gear set P33. When the planetary gear set P33 is designed as a minus gear set as represented in FIG. 7, the second element E323 is formed by a carrier of the planetary gear set P33 and the third element E333 is formed by a ring gear of the planetary gear set P33. In a design of the planetary gear set P33 as a plus gear set, the second element E323 would be formed by the ring gear of the planetary gear set P33 and the second element E333 would be formed by the carrier of the planetary gear set P33.

The main gear set HRS according to the third exemplary embodiment includes precisely three shafts, namely the first shaft Wy31 connected to the output shaft GW2, the second shaft Wy32 connected to the third shaft Wx3 of the front-mounted gear set VRS, and a third shaft Wy33. The second element E323 of the planetary gear set P33 is an integral part of the first shaft Wy31 of the main gear set HRS. The third element E333 of the planetary gear set P33 is an integral part of the second shaft Wy32 of the main gear set HRS. The first element E313 of the planetary gear set P33 is an integral part of the third shaft Wy33 of the main gear set HRS. The third shaft Wy33 is rotationally fixable by engaging a fourth shift element 304. The input shaft GW1 is connectable to the third shaft Wy33 by engaging a fifth shift element.

In the transmission G according to the third exemplary embodiment, the interface B is designed as a spur gear tooth system which intermeshes with a further spur gear tooth system of a shaft which is axially parallel to the output shaft and is not represented in FIG. 7. The main gear set HRS is arranged axially between the interface B and the front-mounted gear set VRS in this case. The interface B is arranged axially between the interface A to the transmission-external drive unit and the front-mounted gear set VRS.

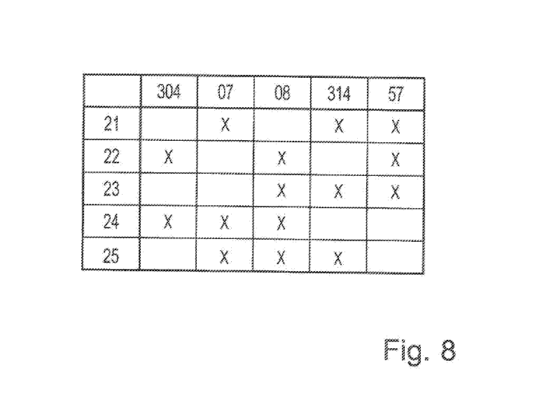

FIG. 8 shows a shift pattern which can be applied for the transmission G according to the third exemplary embodiment. In the rows of the shift pattern, a first to fifth forward gear 21 through 25 are indicated. In the columns of the shift pattern, an X indicates which of the shift elements 304, 07, 08, 234, 314, 57 is engaged in which gear 21 to 25. The gears refer to fixed transmission ratios between the input shaft GW1 and the output shaft GW2 in this case.

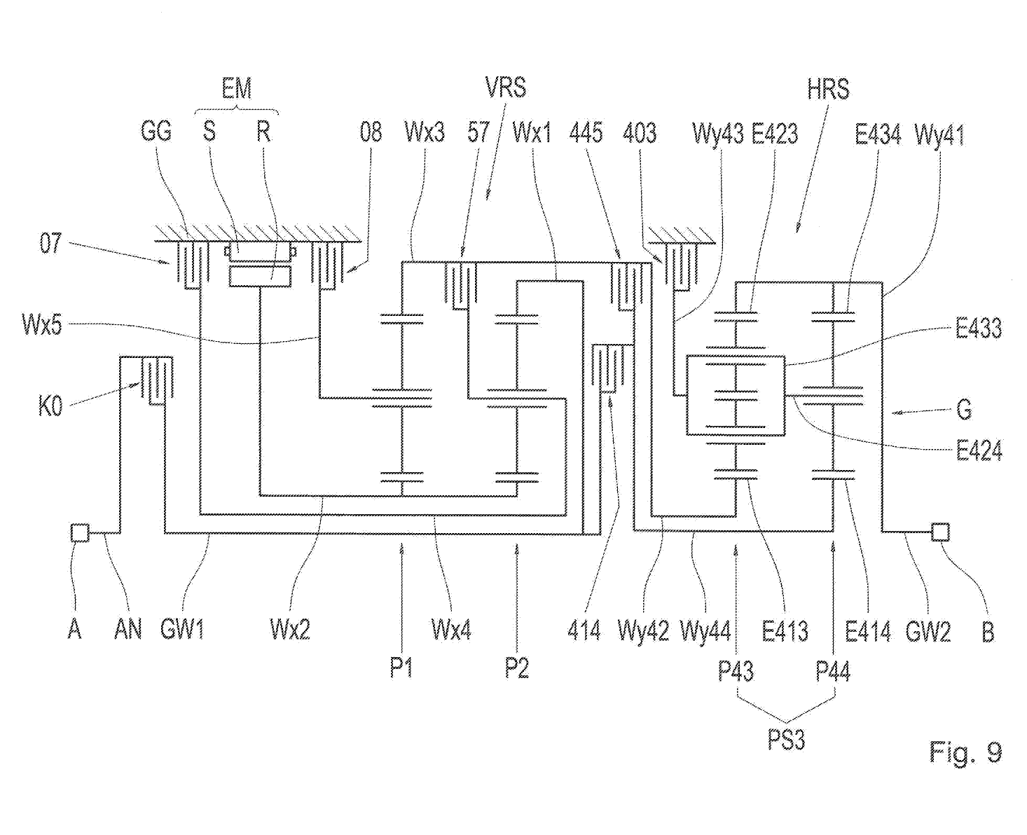

FIG. 9 shows a schematic of a transmission G according to a fourth exemplary embodiment of the invention. The main gear set HRS includes, in this case, a planetary gear set system PS3 which includes a first planetary gear set P43 and a second planetary gear set P44. Each of the two planetary gear sets P43, P44 includes a first element E413, E414, a second element E423, E424, and a third element E433, E434. The first element E413, E414 is formed by a sun gear of the respective planetary gear set P43, P44. When one of the planetary gear sets P43, P44 is designed as a minus gear set, the second element E423, E424 is formed by a carrier of the respective planetary gear set P43, P44 and the third element E433, E434 is formed by a ring gear of the respective planetary gear set P43, P44. When one of the planetary gear sets P43, P44 is designed as a plus gear set, the second element E423, E424 is formed by the ring gear of the respective planetary gear set P43, P44 and the third element E433, E434 is formed by the carrier of the respective planetary gear set P43, P44. In the fourth exemplary embodiment of the transmission G represented in FIG. 9, the first planetary gear set P43 is designed as a plus gear set and the second planetary gear set P44 is designed as a minus gear set.

The planetary gear set system PS3 includes precisely four shafts in this case, namely the first shaft Wy41 connected to the output shaft GW2, the second shaft Wy42 connected to the third shaft Wx3 of the front-mounted gear set VRS, a third shaft Wy43, and a fourth shaft Wy44. A planetary gear set system consisting of two individual planetary gear sets which, together, form four shafts, can also be described by its kinematics. The present configuration of the planetary gear set system corresponds to the known Ravigneaux gear set. The embodiment represented in FIG. 9 is to be considered merely schematically. In an implementation of this example, the main gear set HRS would be designed in the known design of a Ravigneaux gear set, i.e., including a single ring gear and a common set of radially outer planet gears.

In the exemplary embodiment according to FIG. 9, the second element E423 of the first planetary gear set P43 and the third element E434 of the second planetary gear set P44 are integral parts of the first shaft Wy41 of the main gear set HRS which is permanently connected to the output shaft GW2. The first element E413 of the first planetary gear set P43 is an integral part of the second shaft Wy42 of the main gear set HRS, which is permanently connected to the third shaft Wx3 of the front-mounted gear set VRS.

The third element E433 of the first planetary gear set P43 and the second element E424 of the second planetary gear set P44 are integral parts of the third shaft Wy43 of the main gear set HRS. The first element E414 of the second planetary gear set P44 is an integral part of the fourth shaft Wy44 of the main gear set HRS. The third shaft Wy43 is rotationally fixable by engaging a fourth shift element 403. The fourth shaft Wy44 is connectable to the input shaft GW1 by engaging a fifth shift element 414 and is connectable to the second shaft Wy42 by engaging a sixth shift element 445.

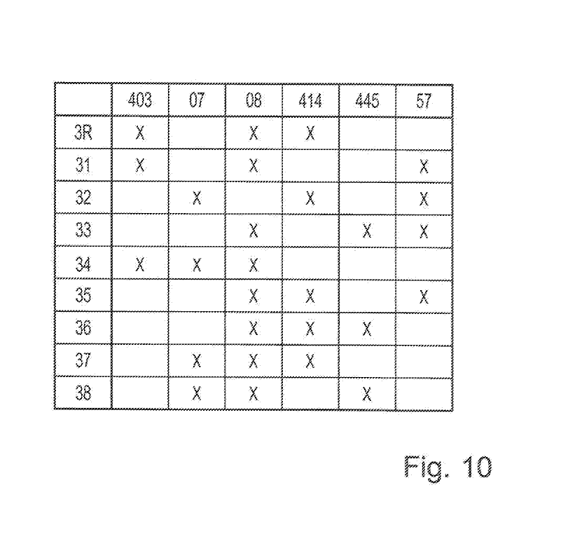

FIG. 10 shows a shift pattern which can be applied for the transmission G according to the fourth exemplary embodiment. In the rows of the shift pattern, one reverse gear 3R and a first to eighth forward gear 31 through 38 are indicated. In the columns of the shift pattern, an X indicates which of the shift elements 403, 07, 08, 414, 445, 57 is engaged in which gear 31 to 38, 3R. The gears refer to fixed transmission ratios between the input shaft GW1 and the output shaft GW2 in this case.

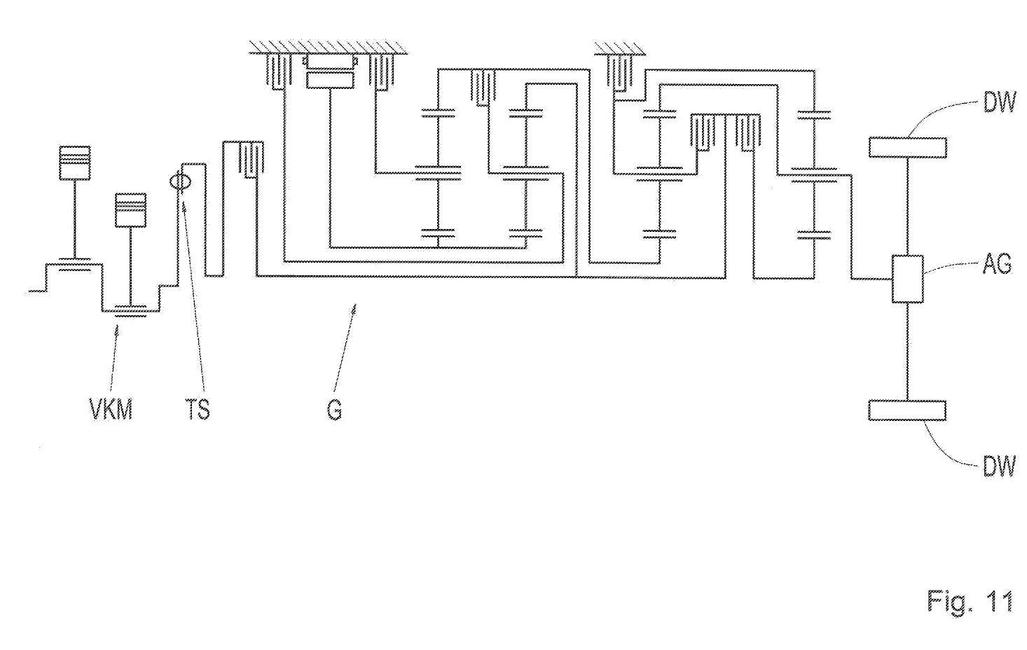

FIG. 11 schematically shows a drive train of a motor vehicle. An internal combustion engine VKM is connected via a torsional vibration damper TS to the connecting shaft AN of the transmission G. The transmission G represented in FIG. 11 corresponds to the first exemplary embodiment of the invention represented in FIG. 1. This is to be considered merely as an example. The internal combustion engine VKM could also be connected via the torsional vibration damper TS directly to the input shaft GW1 of the transmission G. The drive train could be designed with any of the present exemplary embodiments. The drive train could also contain a hydrodynamic torque converter which is to be arranged in the power flow between the internal combustion engine VKM and the input shaft GW1 of the transmission G. Such a torque converter can also include a direct drive or lockup clutch. A person skilled in the art will freely configure the arrangement and the spatial position of the individual components of the drive train depending on the external peripheral conditions. The output shaft GW2 is connected to a differential gear AG, via which the power present at the output shaft GW2 is distributed to driving wheels DW of the motor vehicle.

Modifications and variations can be made to the embodiments illustrated or described herein without departing from the scope and spirit of the invention as set forth in the appended claims.

### REFERENCE CHARACTERS

G transmission
GG rotationally fixed component
GW1 input shaft
GW2 output shaft
A interface
B interface
VRS front-mounted gear set
Wx1 first shaft of the front-mounted gear set
Wx2 second shaft of the front-mounted gear set
Wx3 third shaft of the front-mounted gear set
Wx4 fourth shaft of the front-mounted gear set
Wx5 fifth shaft of the front-mounted gear set
57 first shift element
07 second shift element
08 third shift element
P1 first planetary gear set
E11 first element of the first planetary gear set
E21 second element of the first planetary gear set
E31 third element of the first planetary gear set
P2 second planetary gear set
E12 first element of the second planetary gear set
E22 second element of the second planetary gear set
E32 third element of the second planetary gear set
HRS main gear set
PS1 planetary gear set system
P3 first planetary gear set of the planetary gear set system
E13 first element of the first planetary gear set
E23 second element of the first planetary gear set
E33 third element of the first planetary gear set
P4 second planetary gear set of the planetary gear set system
E14 first element of the second planetary gear set
E24 second element of the second planetary gear set
E34 third element of the third planetary gear set
Wy1 first shaft of the main gear set
Wy2 second shaft of the main gear set
Wy3 third shaft of the main gear set
Wy4 fourth shaft of the main gear set
04 fourth shift element
13 fifth shift element
14 sixth shift element
1-7 first to seventh forward gear
R1, R2 reverse gear
PS2 planetary gear set system
P23 first planetary gear set of the planetary gear set system
E213 first element of the first planetary gear set
E223 second element of the first planetary gear set
E233 third element of the first planetary gear set
P24 second planetary gear set of the planetary gear set system
E214 first element of the second planetary gear set
E224 second element of the second planetary gear set
E234 third element of the third planetary gear set
Wy21 first shaft of the main gear set
Wy22 second shaft of the main gear set
Wy23 third shaft of the main gear set
Wy24 fourth shaft of the main gear set
204 fourth shift element
234 fifth shift element
214 sixth shift element
P33 planetary gear set of the main gear set
E313 first element of the main gear set
E323 second element of the main gear set
E333 third element of the main gear set
Wy31 first shaft of the main gear set
Wy32 second shaft of the main gear set
Wy33 third shaft of the main gear set
304 fourth shift element
314 fifth shift element
21-25 first to fifth forward gear
PS3 planetary gear set system
P43 first planetary gear set of the planetary gear set system
E413 first element of the first planetary gear set
E423 second element of the first planetary gear set
E433 third element of the first planetary gear set
P44 second planetary gear set of the planetary gear set system
E414 first element of the second planetary gear set
E424 second element of the second planetary gear set
E434 third element of the third planetary gear set
Wy41 first shaft of the main gear set
Wy42 second shaft of the main gear set
Wy43 third shaft of the main gear set
Wy44 fourth shaft of the main gear set
403 fourth shift element
414 fifth shift element
445 sixth shift element
31-38 first to eighth forward gear
3R reverse gear
EM electric machine
R rotor
S stator
K0 separating clutch
VKM internal combustion engine
DW wheels
AG differential gear
TS torsional vibration damper

1-15. (canceled)

16. A transmission (G) for a motor vehicle, comprising
an input shaft (GW1);
an output shaft (GW2);
an upstream gear set (VRS) with a first planetary gear set (P1) and a second planetary gear set (P2);
a main gear set (HRS);
an electric machine (EM) with a stator (S) and a rotor (R); and
a plurality of shift elements (57, 07, 08, 04, 13, 14; 204, 234, 214; 304, 314; 403, 414, 445), each of a plurality of fixed transmission ratios (1 to 7; 21 to 25; 31 to 38) between the input shaft (GW1) and the output shaft (GW2) is shiftable by selective engagement of a respective three of the shift elements (57, 07, 08, 04, 13, 14; 204, 234, 214; 304, 314; 403, 414, 445),
wherein the input shaft (GW1) is permanently connected to a first shaft (Wx1) of the upstream gear set (VRS),
wherein the rotor (R) is permanently connected to a second shaft (Wx2) of the upstream gear set (VRS),
wherein the output shaft (GW2) is permanently connected to a first shaft (Wy1, Wy21, Wy31, Wy41) of the main gear set (HRS),
wherein the first and second planetary gear sets (P1, P2) of the upstream gear set (VRS) further include a third shaft (Wx3), a fourth shaft (Wx4), and a fifth shaft (Wx5) in addition to the first shaft (Wx1) and the second shaft (Wx2) such that the the first and second planetary gear sets (P1, P2) of the upstream gear set (VRS) collectively have precisely five shafts (Wx1, Wx2, Wx3, Wx4, Wx5),
wherein the third shaft (Wx3) of the upstream gear set (VRS) is permanently connected to a second shaft (Wy2, Wy22, Wy32, Wy42) of the main gear set (HRS),
wherein the third shaft (Wx3) of the upstream gear set (VRS) is connectable to the fourth shaft (Wx4) of the upstream gear set (VRS) by engaging a first one of the shift elements (57) such that the shafts (Wx1 to Wx5) of the upstream gear set (VRS) assume a rotational speed order of the second shaft (Wx2), the fifth shaft (Wx5), the third shaft (Wx3) together with the fourth shaft (Wx4), then the first shaft (Wx1),
wherein the fourth shaft (Wx4) of the upstream gear set (VRS) is rotationally fixable by engaging a second one of the shift elements (07), and
wherein the fifth shaft (Wx5) of the upstream gear set (VRS) is rotationally fixable by engaging a third one of the shift elements (08).

17. The transmission (G) of claim 16, wherein an absolute value of a stationary transmission ratio of the first planetary gear set (P1) of the upstream gear set (VRS) is greater than an absolute value of a stationary transmission ratio of the second planetary gear set (P2) of the upstream gear set (VRS).

18. The transmission (G) claim 16, wherein:
the first and second planetary gear sets (P1, P2) of the upstream gear set (VRS) each include a first element (E11, E12), a second element (E21, E22), and a third element (E31, E32), the first element (E11, E12) formed by a sun gear of the respective planetary gear set (P1, P2), the second element (E21, E22) formed by a carrier of the respective planetary gear set (P1, P2) in the case of a minus gear set or by a ring gear of the respective planetary gear set (P1, P2) in the case of a plus gear set, the third element (E31, E32) formed by the ring gear of the respective planetary gear set (P1, P2) in the case of the minus gear set or by the carrier of the respective planetary gear set (P1, P2) in the case of the plus gear set;
the third element (E32) of the second planetary gear set (P2) is an integral part of the first shaft (Wx1) of the upstream gear set (VRS);
the first element (E11) of the first planetary gear set (P1) and the first element (E12) of the second planetary gear set (P2) are integral parts of the second shaft (Wx2) of the upstream gear set (VRS);
the third element (E31) of the first planetary gear set (P1) is an integral part of the third shaft (Wx3) of the upstream gear set (VRS);
the second element (E22) of the second planetary gear set (P2) is an integral part of the fourth shaft (Wx4) of the upstream gear set (VRS); and
the second element (E21) of the first planetary gear set (P1) is an integral part of the fifth shaft (Wx5) of the upstream gear set (VRS).

19. The transmission (G) of claim 16, wherein:
the main gear set (HRS) is a planetary gear set system (PS1) which comprises a third shaft (Wy3) and a fourth shaft (Wy4) in addition to the first and the second shafts (Wy1, Wy2) such that the main gear set (HRS) has precisely four shafts (Wy1, Wy2, Wy3, Wy4);
the four shafts (Wy1 to Wy4) of the main gear set (HRS) have a rotational speed order of the second shaft (Wy2), the third shaft (Wy3), the first shaft (Wy1), then the fourth shaft (Wy4);
the third shaft (Wy3) of the main gear set (HRS) is rotationally fixable by engaging a fourth one of the shift elements (04);
the input shaft (GW1) is connectable to the fourth shaft (Wy4) of the main gear set (HRS) by engaging a fifth one of the shift elements (13); and
the input shaft (GW1) is connectable to the third shaft (Wy3) by engaging a sixth one of the shift elements (14).

20. The transmission (G) of claim 19, wherein:
the planetary gear set system (PS1) comprises a first planetary gear set (P3) and a second planetary gear set (P4), each of the first and second planetary gear sets (P3, P4) of the planetary gear set system (PS1) including a first element (E13, E14), a second element (E23, E24), and a third element (E33, E34), the first element (E13, E14) formed by a sun gear of the respective planetary gear set (P3, P4), the second element (E23, E24) formed by a carrier of the respective planetary gear set (P3, P4) in the case of a minus gear set or by a ring gear of the respective planetary gear set (P3, P4) in the case of a plus gear set, the third element (E33, E34) formed by the ring gear of the respective planetary gear set (P3, P4) in the case of the minus gear set or by the carrier of the respective planetary gear set (P3, P4) in the case of the plus gear set;
the second element (E24) of the second planetary gear set (P4) of the planetary gear set system (PS1) and the third element (E33) of the first planetary gear set (P3) of the planetary gear set system (PS1) are integral parts of the first shaft (Wy1) of the main gear set (HRS);
the first element (E13) of the first planetary gear set (P3) of the planetary gear set system (PS1) is an integral part of the second shaft (Wy2) of the main gear set (HRS);
the second element (E23) of the first planetary gear set (P3) of the planetary gear set system (PS1) and the third element (E34) of the second planetary gear set (P4) of the planetary gear set system (PS1) are integral parts of the third shaft (Wy3) of the main gear set (HRS); and
the first element (E14) of the second planetary gear set (P4) of the planetary gear set system (PS1) is an integral part of the fourth shaft (Wy4) of the main gear set (HRS).

21. The transmission (G) of claim 19, wherein:
seven forward gears (1 to 7) and at least one reverse gear (R1, R2) between the input shaft (GW1) and the output shaft (GW2) are shiftable by selective engagement of three of the shift elements (57, 04, 07, 04/204, 13/234, 14/214);
a first forward gear (1) results by engaging the second, the fourth, and the fifth shift elements (07, 04/204, 13/234);
a second forward gear (2) results by engaging the first, the second, and the fifth shift elements (57, 07, 13/234);
a third forward gear (3) results by engaging the second, the third, and the fifth shift elements (07, 08, 13/234);
a fourth forward gear (4) results by engaging the second, the fifth, and the sixth shift elements (07, 13/234, 14/214);
a fifth forward gear (5) results by engaging the second, the third, and the sixth shift elements (07, 08, 14/214);
a sixth forward gear (6) results by engaging the first, the third, and the sixth shift elements (57, 08, 14/214);
a seventh forward gear (7) results by engaging the first, the second, and the sixth shift elements (57, 07, 14/214); and
the reverse gear (R1, R2) results by engaging the third and the fourth shift elements (08, 04/204) together with either the second shift element (07) or the first shift element (57).

22. The transmission (4) of claim 21, wherein:
a first power-split drive mode (EDA1) between the input shaft (GW1), the electric machine (EM), and the output shaft (GW2) results by engaging the third shift element (08) and the fifth shift element (13/234); and
a second power-split drive mode (EDA2) between the input shaft (GW1), the electric machine (EM), and the output shaft (GW2) results by engaging the fourth shift element (04/204) and the first shift element (57).

23. The transmission (G) of claim 19, wherein one or both of the fourth shift element (04/204) and the second shift element (07) is a form-fit shift element or a force-locking frictional shift element with disks that exclusively have non-lined friction faces.

24. The transmission (G) of claim 16, wherein:
the main gear set (HRS) is a planetary gear set system (PS2) which comprises a third shaft (Wy23), a fourth shaft (Wy24), and a fifth shaft (Wy25) in addition to the first and the second shafts (Wy21, Wy22) such that the main gear set (HRS) has precisely five shafts (Wy21, Wy22, Wy23, Wy24, Wy25);
the fifth shaft (Wy25) of the planetary gear set system (PS2) is permanently connected to the input shaft (GW1);
the third shaft (Wy23) of the planetary gear set system (PS2) is rotationally fixable by engaging a fourth one of the shift elements (204);
third shaft (Wy23) of the planetary gear set system (PS2) is connectable to the fourth shaft (Wy24) of the planetary gear set system (PS2) by engaging a fifth one of the shift elements (234) such that the five shafts (Wy21 to Wy25) of the planetary gear set system (PS2) have a rotational speed order of the second shaft (Wy22), the third shaft (Wy23) together with the fourth shaft (Wy24), the first shaft (Wy21), then the fifth shaft (Wy25); and
the input shaft (GW1) is connectable to the third shaft (Wy23) of the planetary gear set system (PS2) by engaging a sixth one of the shift elements (214).

25. The transmission (G) of claim 24, wherein:
the planetary gear set system (PS2) comprises two planetary gear sets (P23, P24), each of the two planetary gear sets (P23, P24) comprises a first element (E213, E214), a second element (E223, E224), and a third element (E233, E234), the first element (E213, E214) formed by a sun gear of the respective planetary gear set (P23, P24), the second element (E223, E224) formed by a carrier of the respective planetary gear set (P23, P24) in the case of a minus gear set or by a ring gear of the respective planetary gear set (P23, P24) in the case of a plus gear set, the third element (E233, E234) formed by the ring gear of the respective planetary gear set (P23, P24) in the case of the minus gear set or by the carrier of the respective planetary gear set (P23, P24) in the case of the plus gear set;
the second element (E224) of the second planetary gear set (P24) of the planetary gear set system (PS2) and the third element (E233) of the first planetary gear set (P23) of the planetary gear set system (PS2) are integral parts of the first shaft (Wy1) of the main gear set (HRS);
the first element (E213) of the first planetary gear set (P23) of the planetary gear set system (PS2) is an integral part of the second shaft (Wy22) of the main gear set (HRS);
the second element (E223) of the first planetary gear set (P23) of the planetary gear set system (PS2) is an integral part of the third shaft (Wy23) of the main gear set (HRS);
the third element (E234) of the second planetary gear set (P24) of the planetary gear set system (PS2) is an integral part of the fourth shaft (Wy24) of the main gear set (HRS); and
the first element (E214) of the second planetary gear set (P24) of the planetary gear set system (PS2) is an integral part of the fifth shaft (Wy5) of the main gear set (HRS).

26. The transmission (G) of claim 24, wherein
seven forward gears (1 to 7) and at least one reverse gear (R1, R2) between the input shaft (GW1) and the output shaft (GW2) are shiftable by selective engagement of three of the shift elements (57, 04, 07, 04/204, 13/234, 14/214);
a first forward gear (1) results by engaging the second, the fourth, and the fifth shift elements (07, 04/204, 13/234);
a second forward gear (2) results by engaging the first, the second, and the fifth shift elements (57, 07, 13/234);
a third forward gear (3) results by engaging the second, the third, and the fifth shift elements (07, 08, 13/234);
a fourth forward gear (4) results by engaging the second, the fifth, and the sixth shift elements (07, 13/234, 14/214);
a fifth forward gear (5) results by engaging the second, the third, and the sixth shift elements (07, 08, 14/214);
a sixth forward gear (6) results by engaging the first, the third, and the sixth shift elements (57, 08, 14/214);
a seventh forward gear (7) results by engaging the first, the second, and the sixth shift elements (57, 07, 14/214); and
the reverse gear (R1, R2) results by engaging the third and the fourth shift elements (08, 04/204) together with either the second shift element (07) or the first shift element (57).

27. The transmission (4) of claim 26, wherein:
a first power-split drive mode (EDA1) between the input shaft (GW1), the electric machine (EM), and the output shaft (GW2) results by engaging the third shift element (08) and the fifth shift element (13/234); and
a second power-split drive mode (EDA2) between the input shaft (GW1), the electric machine (EM), and the output shaft (GW2) results by engaging the fourth shift element (04/204) and the first shift element (57).

28. The transmission (G) of claim 24, wherein one or both of the fourth shift element (04/204) and the second shift element (07) is a form-fit shift element or a force-locking frictional shift element with disks that exclusively have non-lined friction faces.

29. The transmission (G) of claim 16, wherein:
an interface (A) of the transmission (G) to a transmission-external drive unit is arranged coaxially with and at an opposite axial end of the transmission (G) to an interface (B) of the output shaft (GW2) to a transmission-internal or transmission-external differential gear; and
the main gear set (HRS) has a greater axial distance to the interface (A) than the upstream gear set (VRS).

30. The transmission (G) of claim 16, wherein:
an interface (B) of the output shaft (GW2) is a spur gear tooth system which intermeshes with a further spur gear tooth system of a shaft which is axially parallel to the output shaft (GW2); and
the interface (B) of the output shaft (GW2) has a shorter axial distance to an interface (A) of the input shaft (GW1) than the upstream gear set (VRS).

31. The transmission (G) of claim 30, wherein the main gear set (HRS) is arranged axially between the interface (B) of the output shaft (GW2) and the upstream gear set (VRS).

32. The transmission (G) of claim 16, further comprising a connecting shaft (AN) and a separating clutch (K0), the connecting shaft (AN) connectable to the input shaft (GW1) via the separating clutch (K0).

33. A drive train for a motor vehicle, comprising an internal combustion engine (VKM), the transmission (G) of claim 16, and a differential gear (AG) connected to wheels (DW) of the motor vehicle, wherein the input shaft (GW1) of the transmission (G) is torsionally elastically connected via a torsional vibration damper (TS) to the internal combustion engine (VKM) either directly or by a separating clutch (K0), and the output shaft (GW2) of the transmission (G) is operatively connected to the differential gear (AG).
